(19) United States
(12) Patent Application Publication
(10) Pub. No.: US 2006/0278407 A1
(43) Pub. Date: Dec. 14, 2006

(54) Flexible horseshoes, method for attaching and device for making

(76) Inventor: J. Grant Baldwin, Salmon, ID (US)

Correspondence Address: ROBERT L. SHAVER;DYKAS, SHAVER & NIPPER, LLP, PO BOX 877, BOISE, ID, 83701-0877, US

(21) Appl. No.: 11/152,958

(22) Filed: Jun. 14, 2005

(51) Int. Cl. A01L 3/02

(52) U.S. Cl. 168/4

(57) ABSTRACT

A flexible horseshoe which attaches to a horse hoof by threaded attachment screws. The invention also includes the device for cutting the flexible horseshoes, and the method of mounting the flexible horseshoes.

### BACKGROUND OF THE INVENTION

1. Field of the Invention

The present invention generally relates to horseshoes and more particularly to flexible horseshoes.

2. Background Information

A horse's hoof is composed of the wall, the sole and the frog. The wall is the part of the hoof that is visible when the horse is standing. It covers the front and side of the third phalanx of the horse's foot. When a horse's foot is lifted off the ground, the sole and frog become visible if the horse's hoof is turned away from the ground. The wall of the hoof is composed of hard material that is produced continuously and it must be either worn off by wear, or be trimmed off. The hoof wall does not contain blood vessels or nerves, and is like a fingernail in consistency. The frog is a highly elastic wedge shaped mass, which protrudes slightly from the sole of the hoof, and normally makes contact with the ground before other portions of the hoof as the horse is walking. The frog presses up on a structure called a digital cushion which is flattened and forced outward by the frog. The frog is also flattened and tends to push against the bars of the wall which are in turn, portions of the wall which abut the edges of the frog. When horse's foot is lifted, the frog and other flexible structures in the foot, return to their original position.

When a horse's foot is placed on the ground, blood is forced from the foot to the leg by the increase in pressure and by the change in shape of the digital cushion in the frog. The pressure in the changing shape compresses the veins in the foot. When the foot is lifted, the compression is relieved and blood flows into the veins again. In this way, the movement of these structures in the hoof acts as a pump. Exercise increases the blood circulation in the horse's foot and favors good hoof growth.

Normally the hoof wall grows at the rate of about ⅜ inch per month. New layers of the hoof wall are produced continuously from just below the junction of the skin and hoof wall.

If the horse travels long distances or runs over hard ground, they typically have shoes placed on their hooves to reinforce and protect the wall of the hoof. Since the wall of the hoof and the frog continually grow, about every 4-6 weeks a farrier needs to replace the horseshoes attached to a horse's hoof. The horseshoe also strengthens the wall of the hoof and prevents it from splitting under stress or impact on hard surfaces.

A typical method of shoeing a horse is for the farrier to first remove the existing shoes. This step will be described after the process of putting on new shoes is described. To put on new shoes, the farrier first cleans out the area inside the hoof wall. He then trims the hoof frog and smoothes and trims the edge of the hoof wall. Both of these structures are continually growing, and part of the process of shoeing involves trimming them back. The farrier then must place the correct size steel shoe on the horse's hoof, and nail it in place with nails. The nails go through holes in the shoe, and pierce the hoof wall. Where the nails stick out of the hoof wall, the tips are bent over to secure the nails in the hoof wall.

The farrier must also adjust the shoes so that they are the right size for a particular horse. This is best accomplished by heating the horseshoe until it is red hot, then forming it with a hammer while it is in a malleable state. Then the horseshoe is quenched in water, and horseshoeing can proceed.

One problem that arises in a typical horseshoeing scenario is that horses don't particularly like to have the bottoms of their hooves pounded on with a hammer. Although some horses can be trained to be quiet during this procedure, other horses may pull their hoof away from the farrier to stop the pounding. This can be very dangerous for the farrier, because he may hurt his back in this process, and nails sticking out of the edges of the hoof can severely injure the farrier.

Another problem with conventional horseshoes is that the steel of the horseshoes can be very slippery on certain surfaces. Thus, on smooth concrete and stones, steel horseshoes are very slippery and can cause a horse to fall and be injured.

What is needed is a horseshoe that provides a better gripping surface than the conventional horseshoe provides. Another thing that is needed is a horseshoe which can be attached to a horse's hoof without the need for hammering, and without the use of nails. A further objective of the invention is a machine which makes horseshoes from a flexible material.

The invention is a flexible pad made for the protection of horses' hooves. This replaces, and is an alternative to, the conventional method of shoeing a horse, which is by nailing a metal horseshoe to the underside of the horses' hooves. The purpose of the flexible pads is to provide a more shock absorbent surface for the horses' hooves. They are also much easier to attach, and can be used to help heal cracks in the hooves. Horses do not like being shoed and do not like having their hooves struck with a hammer in the nailing process. Because attaching these shoes does not require nailing, it is easier to get a horse to cooperate with the application of these shoes.

Conventional shoes also have preformed nail holes, which may be in a disadvantageous location. The flexible pads of the present invention need not have predrilled nail holes, and the screw can penetrate the pad wherever it is most advantageous for the horse and the farrier.

These flexible pads are more shock absorbing, and also provide a better grip for the animal on hard surfaces, such as wet pavement, concrete, and icy surfaces. They are also less damaging to the surface because they do not contain metal. However, the screw heads of the invention can be left protruding, or can even be designed for more protrusion, and these can provide additional grip for the horse on slippery surfaces. An important feature of the invention is that the shoe treads are held in place on the hoof by screws instead of nails. The screws can have recessed heads for use on streets or floors, or protruding heads to provide better traction on ice or smooth surfaces.

The pad is comparatively soft and cushions the horse when walking or running. The shape protects the tender middle (frog) of the hoof. It also keeps snow and mud from balling and accumulating in the frog area. The screws eliminate the dangerous nailing process, and are easier to use with the horse because the horse is calmer during shoeing. Screws virtually never become loose like nails tend to do. In traditional horseshoeing, nails are driven through the outer edge of the hoof and are crimped on the outside of the hoof. They frequently become un-crimped, and then become loose. Removing the flexible pads of the invention is much easier than removing nails of prior art horseshoes.

The invention eliminates loose shoes, which are the result of poor fit or hard use. They are a lower cost alternative to horseshoeing because rubber is simpler and requires less precision to install. It is also easier to shoe horses in this manner because the horses tend to cooperate more. These flexible pads are an improvement over factory made shoes because they allow the screws to be placed in the best position for the horse, and they do not have to be placed through pre-made nail holes as with factory made shoes. These shoes also eliminate the rim of traditional horseshoes, which tend to trap snow and cause ice balls in the frog area. The ice balls, with the tenderness of the frog area, cause the horse to be unstable and uncomfortable.

A particularly advantageous shoe can be made utilizing used automobile tires. A tool to press the horseshoe treads out of automobile tires is shown in the attached figures. A die is pressed through the sidewall of the automobile tire, using mechanical leverage, hydraulic, electric, or other power to push the die through the sidewall of the tire. The convex curvature of the sidewall is advantageous in that it tends to press into the interior of the hoof, and serves as a device to push snowballs, and other debris, out of the interior of the hoof. This has an effect similar to the anti-balling plates used by mountain climbers on crampons. In the case of crampons, a plastic sheet is placed under the points of the crampon and tends to eject balls of snow, keeping them from binding to the crampons. This device has a similar effect, and the flexible pads tend to pop snowballs out and keep debris from accumulating around the frog.

Similar shoes could also be made for oxen, bulls, or mules. The shoe can be made in a generally “horseshoe” shape, which is a partial ellipsoid or ovoid with a portion removed from one of the ends of the ellipsoid. The shoe can be made from a piece of flexible material which covers the entire bottom surface of the horse's hoof. One particularly advantageous form is a shoe which has an indentation that extends from the rear of the horse's hoof towards the center in a generally V-shaped indentation. Various types of screws can be utilized to either be recessed or to extend, or to fit various tools to make them easy to install or extract. The preferred screws are self-tapping and do not need pilot holes, and also help prevent the hoof from cracking.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

These and other objects are accomplished by the flexible horseshoes of the invention. The invention includes a flexible horseshoe set which is attached to the bottom of a horse hoof, and which replaces a traditional steel or rubber horseshoe. The traditional steel or rubber horseshoe is a generally ovoid shape which is open in one portion, so that the two ends of the ovoid ring do not form a complete ring. The traditional horseshoe is approximately one-half inch to three-quarter inch in width, and encircles about 270° of the circumference of a horse's hoof and is open in the center, leaving the sole and frog uncovered.

The flexible horseshoe set of the invention includes a generally ovoid pad body which has a first side and a second side. The pad body includes an outside edge which is generally convex. It also includes a generally v-shaped indentation, with an inside edge formed along the edge of the indentation. The outside edge corresponds to the contour of the hoof wall of a horse hoof, and the generally v shaped inside edge corresponds to the outside contour of the frog of the horse hoof. The pad body is configured for attachment to the wall of the horse hoof. The horseshoe set includes a means of attachment, for attaching the pad body to the hoof wall of the horseshoe. The pad body is shaped to cover generally the entire bottom surface of the horse hoof, except for the v-shaped frog.

The means of attachment of the pad body can be by any conventional means of attachment, including use of adhesive, nails, or preferably by use of a plurality of threaded attachment screws. The attachment screws can have a number of different shapes of heads, which would be on the second side of the pad body when it is installed on a horse hoof. The screws of the heads could be flush, which could be advantageous for some surfaces. The heads of the screws could also protrude varying distances from the surface of the pad body, and in this version would provide varying degrees of traction depending on the specific purpose. Thus, a protruding screw head could provide traction to a horse on icy surfaces or slippery surfaces. The screw heads themselves can take a number of forms including a hex bolt form, a form compatible with an Allen wrench, and a form compatible with Phillips, slot or other driving tools. The use of threaded screws is particularly advantageous, because it eliminates the pounding on a horse's hoof which is usually associated with the shoeing process. When threaded screws are used, once the pad body is secured by screws in the horse hoof, any protruding screw points can easily be clipped off by a tool selected for that purpose.

Although the pad body can be made in a perforated version with pilot holes in place for the passage of nails or screws, a version that is non-perforated is particularly useful. By being non-perforated, the flexible horseshoe pad body is easy to manufacture, and allows the applicator the choice of where specific screw positions are placed. If the pad body is made from the sidewalls of automobile tires or the equivalent, a self-tapping screw easily penetrates the material, and is installed on a horse much more easily than a traditional shoe which is hammered in place by nails.

The flexible horseshoe set may be configured so that the first side and the second side are generally identical in surface contour. The pad body can also be constructed with a tread on the second side of the pad, to increase the grip that a horse experiences on the surface he is walking on. Besides having a tread, it can also have selectively raised portions such as around the periphery of the pad body, or across the center of the pad body. The choice of placement of the raised sections or tread can be made based upon the individual needs of the horse such as to compliment a horse's rehabilitation program or to help the horse heal from a hoof injury or bruise.

The invention also includes a method for placing shoes upon horse's feet. The method includes the step of placing on the horse's hoof a pre-formed flexible horseshoe. The flexible horseshoe applied in this step is a generally ovoid pad body with a first and second side, and a generally convex outside edge, in which the generally convex outside edge corresponds to the contour of the hoof wall, in which the pad body is configured for attachment to the wall of a horse hoof. The method also includes the step of attaching the pad body to the horse's hoof without nailing, by the use of a number of threaded screws which penetrate the pad body and secures the pad body to the hoof wall. The method described above can be modified to include a pad body which is unperforated or perforated with nail or screw pilot holes. The method described above can also be modified to include the use of a pad body which includes a generally v-shaped indentation which corresponds to the generally v-shape of a frog of a typical horse hoof.

The method described above can further include the step of trimming the flexible horseshoe pad body to more closely conform to the shape of the horse's hoof.

The method described above can be further modified to include a flexible horseshoe pad body which is formed by pressing an ovoid cutting die through the side wall of an automobile tire, to produce a generally ovoid shaped pad body.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective view of the flexible pad of the invention.

FIG. 2 is a perspective view of the cut die of the invention.

FIG. 3 is a perspective view of the cutting device of the invention.

### DETAILED DESCRIPTION DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

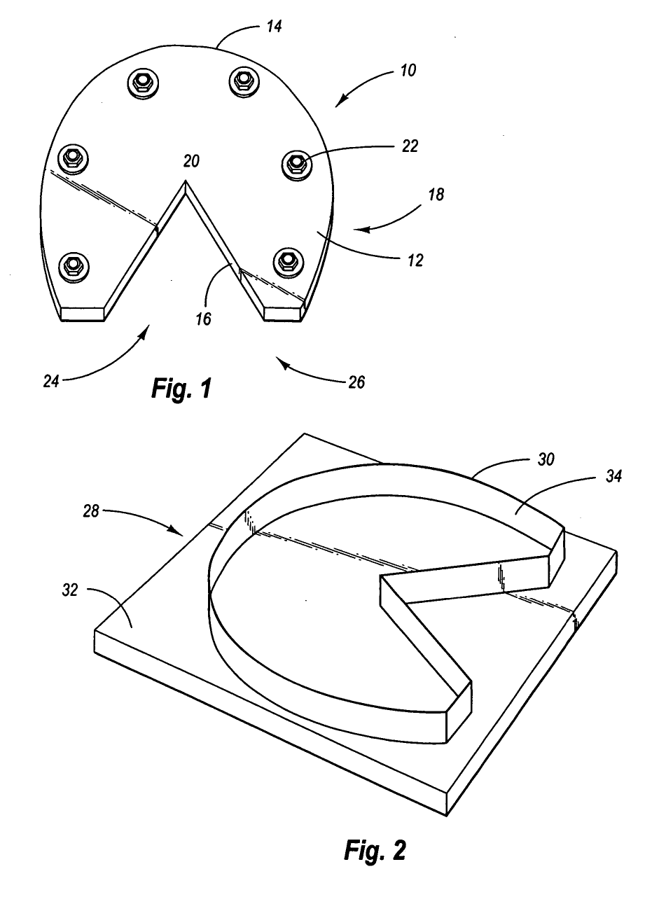

Several preferred embodiments of the invention are shown in FIGS. 1-3. FIG. 1 shows the flexible horseshoe 10 of the invention. The flexible horseshoe 10 is also used in the claimed method for shoeing horses. The flexible horseshoe 10 includes a pad body 12 which has a first side 18 and a second side 20. The second side 20 is the side which when secured to a horse's hoof, faces away from the horse's hoof. The first side 18 is mounted adjacent to the sole of a horse's hoof. The flexible horseshoe includes a means of attachment which is preferably in the form of attachment screws 22. These are threaded screws which can have heads of various types. For instance, they can have a hex head, or a head which is designed to be flush with the surface of a second side 20. The heads can be configured for use with a hex socket, an Allen wrench, a star drive, slot or Phillips screwdrivers, or other conventional screw head driving systems. The pad body 12 is generally ovoid in shape, and has a convex outside edge 14. On one side is located a v-shaped indentation 24, with the v-shaped indentations generally accommodating the v-shape of the frog of a horse's hoof. An inside edge 16 defines the edge of the pad body 12 at the v-shaped indentation 24. The v-shaped indentation 24 is located on the rear 26 of the pad body 12.

One preferred embodiment of the invention utilizes a flexible horseshoe 10 made from an automobile tire. The ovoid pad body 12 is cut from the side or tread of an automobile tire and trimmed as necessary to fit the profile of a particular horse. The preferred embodiment does not utilize pilot holes for the attachment screws 22 since self-tapping screws easily penetrate the pad body 12. However, it would also be possible to provide pilot holes, and such a flexible horseshoe with pilot holes would still fall within the concept of the invention.

FIG. 2 shows a cutting die 28 which can be utilized to cut the flexible horseshoe 10 from an automobile tire. The cutting die 28 includes a cutting edge 30 mounted on a wall 34. The wall 34 is mounted on a base plate 32. The wall 34 with its cutting edge 30 defines the shape of a flexible horseshoe 10 and when pressed against an automobile tire, cuts out a section of the automobile tire in the shape of the flexible horseshoe shown in FIG. 1. The preferred configuration of the cutting die 28 utilizes a die wall 34 which is approximately 5¼ inches from left to right, and 1 inch in height. The sides of the v are approximately 5¼ inches long. The wall is approximately 1 inch high, and made of steel.

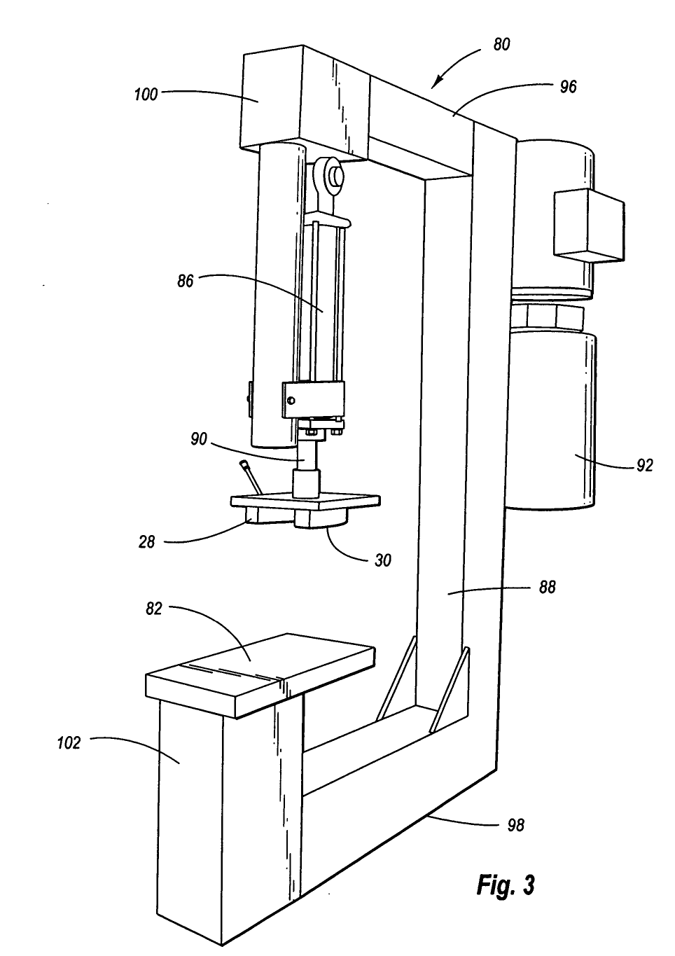

FIG. 3 shows the device of the invention which is used to cut flexible horseshoe 10 from flexible material. The flexible material can be automobile tires, but this machine would also be suitable to cut flexible horseshoe 10 from other types of flexible material. The device 80 includes a frame 88 with an attached flat pressing surface 82. The frame is generally c-shaped, with a back 94, a top side 96 and a bottom side 98. The hydraulic cylinder 86 is mounted to a top flange 100 of the device. In this configuration, the flat pressing surface 82 is mounted to a bottom flange 102 of the device. A motor 92 drives a hydraulic piston 90 to extend from the hydraulic cylinder 86, which has attached to it a cutting die 28. The cutting die 28 is pressed into flexible material (not shown) against the flat pressing surfaces 82 and a flexible horseshoe 10 is cut by the cutting edge 30 of the cutting die 28.

The invention also includes a method for placing shoes on horses' hooves which includes a first step of placing a flexible horseshoe 10 against the horse's hoof. The flexible horseshoe used will be as described above, and as shown in FIG. 1. The flexible horseshoe is preferably attached without nailing, using a number of threaded screws which penetrate the flexible horseshoe and secures the pad body to the hoof wall. The shoe utilized in this method is preferably unperforated until it is mounted and is perforated by the penetration of the attachment screws. Such a shoe would then be trimmed to fit the exterior circumference of a horse's hoof, if necessary. Perforated shoes with a pilot hole for the screws are also a possible version.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A flexible horseshoe set for attachment to a horse hoof bottom surface, with the horse hoof including hoof wall, a hoof sole, a hoof bar of wall, and a generally v shaped hoof frog, comprising:
a generally ovoid pad body, with a first side and a second side, and an outside generally convex edge, and a generally v shaped indentation defined by an inside edge, in which said outside generally convex edge corresponds to the contour of said hoof wall, and said generally v shaped inside edge corresponds to the outside contour of the frog of said horse hoof, and said pad body is configured for attachment to said wall of a horse hoof; and
a means of attachment; wherein said pad body is shaped to cover generally the entire hoof bottom surface except the frog.

2. The flexible horseshoe set of claim 1, in which said means of attachment comprise a plurality of threaded attachment screws.

3. A flexible horseshoe set for attachment to a horse hoof bottom surface, with the horse hoof including hoof wall, a hoof sole, a hoof bar of wall, and a generally v shaped hoof frog, comprising:
a generally ovoid pad body, with a first side and a second side, and an outside generally convex edge, and a generally v shaped indentation defined by an inside edge, in which said outside generally convex edge corresponds to the contour of said hoof wall, and said generally v shaped inside edge corresponds to the outside contour of the frog of said horse hoof, and said pad body is configured for attachment to said wall of a horse hoof; and
a plurality of threaded screws for attachment of said pad body to said horse hoof; wherein said pad body is shaped to cover generally the entire hoof bottom surface except the frog.

4. The flexible horseshoe set of claim 1, in which said pad body is non-perforated, containing no holes for passage of said means of attachment.

5. A flexible horseshoe set for attachment to a horse hoof bottom surface, with the horse hoof including hoof wall, a hoof sole, a hoof bar of wall, and a generally v shaped hoof frog, comprising:
a generally ovoid pad body, with a first side and a second side, and an outside generally convex edge, and a generally v shaped indentation defined by an inside edge, in which said outside generally convex edge corresponds to the contour of said hoof wall, and said generally v shaped inside edge corresponds to the outside contour of the frog of said horse hoof, and said pad body is configured for attachment to said wall of a horse hoof, and in which said pad body is non-perforated, and contains no holes for passage of nails or screws; and
a plurality of threaded screws for attachment of said pad body to said horse hoof; wherein said pad body is shaped to cover generally the entire hoof bottom surface except the frog.

6. The flexible horseshoe set of claim 1, in which said first side and said second side of said pad body are identical in surface contour.

7. The flexible horseshoe set of claim 1, in which said pad body is of a uniform thickness throughout.

8. The flexible horseshoe setoff claim 1, in which said pad body is thicker around said outside generally convex edge.

9. A method for placing shoes upon horses hooves, said method comprising:
placing on a horse hoof a preformed a flexible horseshoe comprising a generally ovoid pad body, with a first side and a second side, and an outside generally convex edge, in which said outside generally convex edge corresponds to the contour of said hoof wall, with said pad body is configured for attachment to said wall of a horse hoof, and
attaching said pad body to said horses' foot without nailing, using a plurality of screws which penetrate said flexible horseshoe and secure the pad body to the hoof wall.

10. The method of claim 9 which further includes the step of placing on said horse hoof a flexible horseshoe which is unperforated with nail or screw holes.

11. The method of claim 9 in which said shoe tread defines a generally v shaped indentation extending from the rear of the shoe tread toward the center of the shoe tread, forming a generally v shaped inside edge which generally corresponds to the outside contour of the frog of said horse hoof.

12. The method of claim 9 which further comprises the step of trimming said shoe tread to conform to the shape of said horses hoof.

13. The method of claim 1 wherein said flexible horseshoe pad body is formed by pressing a cutting die through a sidewall of an automobile tire.

14. A device for manufacturing flexible horse shoes from a flexible material comprising:
a flat pressing surface, for supporting a material to be cut;
a cutting die, for pressing against said material to be cut against said pressing surface; and
a means of pressing said cutting die to press against said flat pressing surface, wherein said device is configured to press said cutting die into said flexible material against said pressing surface, to cut a selected generally ovoid shaped horseshoe out of said flexible material.

15. The device of claim 14 which further includes a generally C shaped frame, comprising a frame back, a frame top arm with an attached top arm extension, a frame bottom arm with an attached bottom arm extension, with said pressing surface attached to said bottom arm extension, and with cutting die extendably attached to said top arm extension, wherein said cutting die is configured to press against a flexible material on said pressing surface, and to cut out an ovoid horseshoe from said flexible material.

16. The device of claim 14, in which said means of pressing said cutting die into said flexible material is a hydraulic cylinder powered by a hydraulic system.

17. A device for manufacturing flexible horse shoes from a flexible material comprising:
a generally C shaped frame, comprising a frame back, a frame top arm with an attached top arm extension, a frame bottom arm with an attached bottom arm extension,
a flat pressing surface, attached to said frame, for supporting a material to be cut;
a cutting die, extensibly attached to said frame, for pressing against said material to be cut against said pressing surface; and
a hydraulic system with a hydraulic cylinder for pressing said cutting die into said flexible material against said flat pressing surface.

18. The device of claim 17 which is configured for cutting ovoid horseshoes from automobile tires.
